(19) United States
(12) Patent Application Publication
(10) Pub. No.: US 2018/0364199 A1
(43) Pub. Date: Dec. 20, 2018

(54) METHOD AND DEVICE FOR DETERMINING QUALITY OF A BOND

(71) Applicant: Nederlandse Organisatie voor toegepast natuurwetenschappelijk onderzoek TNO, 's-Gravenhage (NL)

(72) Inventors: Lotfollah Pahlavan, 's-Gravenhage (NL); Mariana De Soares Silva e Melo Mota, 's-Gravenhage (NL); Mirco Verze, 's-Gravenhage (NL); Christos Kassapoglou, Delft (NL)

(73) Assignee: Nederlandse Organisatie voor toegepast- natuurwetenschappelijk onderzoek TNO, 's-Gravenhage (NL)

(21) Appl. No.: 16/063,339

(22) PCT Filed: Dec. 16, 2016
(86) PCT No.: PCT/NL2016/050885

§ 371 Date: Jun. 18, 2018

(30) Foreign Application Priority Data
Dec. 18, 2015 (EP) 15201312.4

(51) Int. Cl. G01N 29/04; G01N 29/44; G01N 29/11; G01N 29/265

(52) U.S. Cl. CPC G01N 29/043; G01N 29/4427; G01N 29/11; G01N 2291/267; G01N 2291/0231; G01N 2291/2694; G01N 29/265

(57) ABSTRACT

A method and device are discussed for determining quantitative parameters of a bond between two elements, for example an adhesive bond between two aluminium plates of an aircraft. A pulsed wave is provided to a first element. The elements, including the bonded region, act as a waveguide. Any discontinuities, an end of the bonded region or imperfections, result in a change of parameters of the waveguide. This results in reflections. By analysing characteristics of the reflections, along with the actual bond length and a signal expected from a good quality bond, an equivalent bond length may be determined.

### TECHNICAL FIELD

The various aspects relate to inspection of a bonded structure comprising two elements bonded to one another by means of a bonding material.

### BACKGROUND

With the ascend of aluminium as main material for aircraft, plates were attached using adhesives in combination with riveting. Whereas rivets are still used for manufacturing of hulls, wings and other parts of aircraft, use of adhesive-only connections is gaining ground. Whereas quality of a connection by means of rivets can at least partially be inspected from the outside, inspection of an adhesive bond by conventional tools is challenging. The same issue also holds for adhesively-bonded composite parts made of fibre-reinforced plastics.

Various non-destructive methods for inspection of glued bonds exist, like performing a C-scan. However, a C-scan fails to detect zero-volume disbonds, and other methods predominantly provide qualitative data on the bond.

### SUMMARY

It is preferred to provide an improved method for inspection of a bond between two elements.

A first aspect provides a method of determining an effective area of a bond for binding a first element to a second element at a first location, the bonding region having a bonding length between a proximal end and a distal end.

The method comprises sending, by a transmitter operationally connected to the first element outside the bonding region and closer to proximal end than to the distal end, a transmitted signal to the bonding region via the first element and receiving, by a receiver operationally connect to the first element or the second element, a traveled signal resulting out of the transmitted signal having traveled through at least part of the bonding region.

The method further comprises determining, from the received traveled signal, at least one value characterising the traveled signal. Data on an intended traveled signal having traveled through an intended bonding region is obtained and, based on the traveled signal, the value characterising the traveled signal and the bonding length, an equivalent bond area of the bonding region is determined.

The first element acts as a waveguide for the emitted signal. Imperfections of the bond result in a change of characteristics of this waveguide as a function of distance from the transmitter. And this change of characteristics may result in particular reflection and transmission factors of the bonding region having their effect on the emitted signal travelling through the bonding region. By analysing characteristics of the traveled signal along with characteristics expected from a qualitatively good bond, an equivalent bond area may be determined. This may be done by firstly determining an effective bond length, as part of a one-dimensional measurement. Subsequently, the effective bond area may be determined by processing consecutively obtained effective bond lengths, multiplied by a distance between a first and a last point at which effective bond lengths are obtained.

If the bond under inspection is good, the equivalent bond area—or bond length—is substantially equal to the actual bond area—or bond length. If the bond under inspection is flawed, either in whole or in part, the equivalent bond length will be shorter. The equivalent bond length provides a quantitative measure of the quality of the bond.

In an embodiment of the first aspect, the traveled signal is a reflected signal being at least part of the transmitted signal reflected by the bonding region and the receiver is operationally connected to the first element for receiving the reflected signal. The method according to this embodiment comprises determining, from the reflected signal, a distal reflected signal portion reflected by the distal end of the bonding region; and determining, from the reflected signal, a first intermediate signal portion reflected by a first intermediate location in the bonding region between the proximal end and the distal end. Furthermore, in this embodiment, determining at least one value characterising the first traveled signal comprises determining at least one value characterising the first intermediate signal portion; obtaining data on an intended traveled signal by an intended bonding region comprises obtaining data on an intended reflection by the intended bonding region; and determining an equivalent bond length of the bonding region is also based on the data on the intended reflection and the value characterising the first intermediate signal portion.

By providing the transmitter and the receiver on one and the same element and a the same side of the bond, a signal reflected by the bonding region may be received. The reflected signal may comprise various signal portions, resulting out of various reflections of the emitted signal at various locations in the bonding region. The proximal end as well as the distal end of the bonding region provide reflections. And failure locations may cause reflections. It is noted that for example, for cohesive failure, there would be no intermediate reflections. Also the distal end of the bond provides a reflection. An advantage of this embodiment is that transmitter and receiver may be provided in a single module—or even as a single element. Furthermore, as in this embodiment multiple reflected portions are available in a reflected signal, as compared to a substantially single transmitted signal portion arriving in the second element, this embodiment provides more distinguishable portions for obtaining data. It is noted the transmitted signal arriving at the second element may comprise multiple portions as well, yet these are generally more difficult to analyse.

A further embodiment of the first aspect comprises determining, based on the value characterising the first intermediate signal portion, a first transparency factor of the first intermediate location; and determining, based on the intended reflection, the first transparency factor, the distal reflected signal, the value characterising the first intermediate signal portion, and the bonding length, an equivalent bond length.

The transparency factor may be conveniently determined, for example by determining amplitudes or powers of received signal portions.

Another embodiment comprises obtaining a multitude of further received traveled signals at further locations; determining, from the multitude of further traveled signals, at least one value characterising each of the further traveled signals having traveled through the bonding region; and determining, based on at least one value characterising each of the further distal traveled signal portions, data on the intended signal having traveled through by the intended bonding region.

In practical cases, by far the largest part of the bond will have a good quality. By obtaining a large amount of experimental data, most data will relate to bonds having a good quality. To provide even more accurate data, statistical operators may be used on the experimental data, like removing outliers before determining a median or average of a reflected signal or parameters thereof.

In a further embodiment, the data on the intended traveled signal comprises an intended transfer function of the bonding region. This intended transfer function may be conveniently obtained by means of numerical simulations of the bonded structure.

In yet another embodiment, determining the effective bond length further comprises adjusting the distal reflected signal portion based on the value characterising the first intermediate signal portion and convolving the adjusted distal reflected signal portion with the intended transfer function of the bonding region. Convolution is a well known operation that may be resolve in an analytical or numerical way.

A second aspect provides a device for determining an effective area of a bond for binding a first element to a second element by means of a transmitter connected to the first element and a receiver operationally connected to the first element or the second element, the bonding region having a bonding length between a proximal end proximal to the transmitter and a distal end distal to the transmitter. The device comprises an input unit arranged to receive, from the bonding region, by the receiver, a traveled signal resulting out of the transmitted signal having traveled through at least part of the bonding region; and a processing unit. The processing unit is arranged to: determine, from the traveled signal, at least one value characterising the traveled signal. The processing unit is further arranged to obtain data on an intended traveled signal having traveled through an intended bonding region, and determine, based on the traveled signal, the value characterising the traveled signal and the bonding length, an equivalent bond length of the bonding region.

An embodiment of the second aspect provides a device for determining an effective area of a bond for binding a first element to a second element by means of a transmitter and a receiver operationally connected to the first element, the bonding region having a bonding length between a proximal end proximal to the transmitter and a distal end distal to the transmitter. The device comprises an input unit arranged to receive, from the bonding region, by the receiver, a reflected signal, reflected by the bonding region; and a processing unit. The processing unit is arranged to: determine, from the reflected signal, a distal reflected signal portion reflected by the distal end of the bonding region and determine, from the reflected signal, at least a first intermediate amplitude of at least a first intermediate signal portion reflected by a first intermediate location in the bonding region between the proximal end and the distal end. The processing unit is further arranged to obtain data on an intended reflection by an intended bonding region, and determine, based on the intended reflection, the first intermediate amplitude, the distal reflected signal and the bonding length, an equivalent bond length of the bonding region

A third aspect relates to a computer programme product comprising code enabling a processing unit of a computer, when loaded in the processing unit, to execute the method according to the first aspect and embodiments thereof.

### DESCRIPTION OF THE FIGURES

The various aspects and embodiments thereof will now be discussed in detail in conjunction with figures. In the figures,

FIG. 1: shows a bonded structure, an inspection probe and a computer;

FIG. 2: shows a detail of the bonded structure;

FIG. 3: shows a flowchart depicting a procedure for analysis of inspection data;

FIG. 4: shows an example of a received signal; and

FIG. 5: shows intensity charts of received signals.

### DETAILED DESCRIPTION

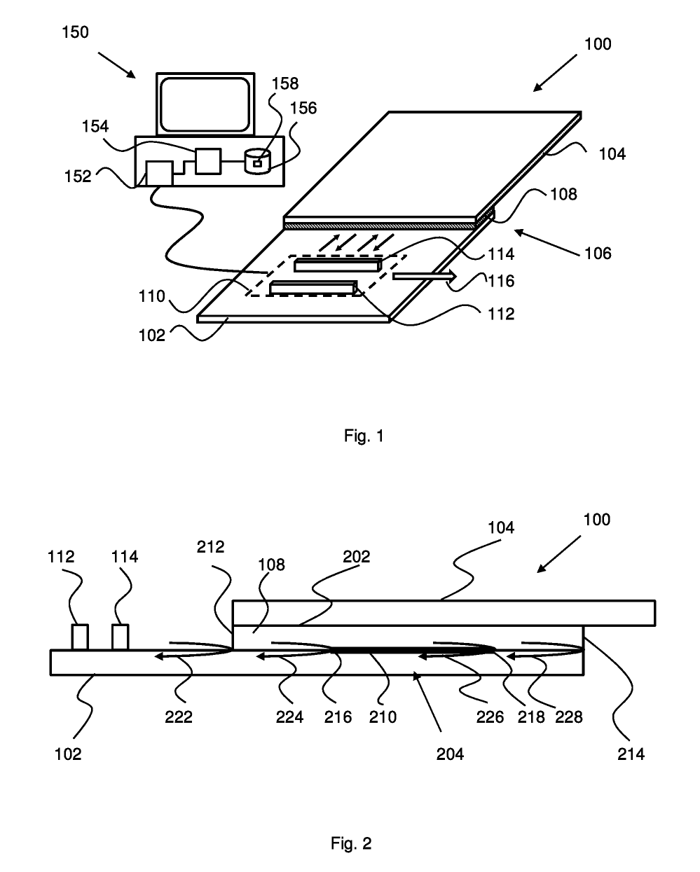

FIG. 1 shows a bonded structure 100 comprising a first aluminium plate 102 as a first bonded element, a second aluminium plate 104 as a second bonded element and a bonding adhesive 108 providing a bond between the first aluminium plate 102 and the second aluminium plate 104. In this embodiment, the bonding material is FM73 film adhesive, but other adhesives may be used as well. In yet another embodiment, no bonding material is present and two elements are bonded together by means of direct welding techniques. The bonded structure 100 may be a part of an aircraft, a car, a ship, a house or another moving or non-moving object.

FIG. 1 also shows an inspection probe 110 connected to a computer 150 as a processing device. The inspection probe comprises a transmitter 112 and a receiver 114. The transmitter 112 comprises an electromagnetic acoustic transducer for exciting an acoustic, preferably ultrasonic, signal in the first aluminium plate 102. Alternatively or additionally, the transmitter 112 comprises another acoustic transducer like a piezo-electric transducer. Transducers of other types may be used as well, including electromagnetic transducers operating in various frequency ranges, including those of microwave, infrared, visible light, ultraviolet and X-ray. The receiver 114 is in this embodiment a distinctly different element, preferably a discrete element. In a further embodiment, the inspection probe 110 comprises multiple transmitting elements and receiving elements as part of the transmitter 112 and the receiver 114, respectively. In another embodiment, the inspection probe 110 comprises one or more electromagnetic acoustic transducer arranged to act as transceivers—transmitter and receiver.

The computer 150 comprises a data communication module 152 for communicating with the inspection probe 110. In this embodiment, the data communication module 152 controls the components of the inspection probe 110 directly. In another embodiment, the inspection probe 110 comprises additional control circuitry as an interface between the data communication module 152 and the transmitter 112 and the receiver 114. The computer 150 further comprises a processing unit 154 and a memory module 156. The memory module 150 comprises in this embodiment a harddisk drive. Alternatively or additionally, the memory module 150 comprises a solid state memory module. The memory module 156 has computer executable code 158 stored on it. The computer executable code 158 enables the processing unit 154 to execute a process discussed below.

The inspection probe 110 is, in conjunction with the computer 150, arranged for inspecting the bond 106. To this purpose, the inspection probe 110 is placed in vicinity of the bond 106 and preferably such that the transmitter 114 and the receiver 116 are provided on a line substantially perpendicular to the bond 106. The inspection probe 110 is driven in movement along the bond 106, preferably substantially parallel to the bond 106 in the direction of a block arrow 116, at substantially the same distance from the bond 106. During this movement, the transmitter 112 sends out signals. The signals are preferably sent out intermittently, in pulses. The signals may have a single frequency or multiple frequencies. Frequencies in the range from 50 kHz to 200 kHz are preferred, sent out in pulses of preferably 10 microseconds to 30 microseconds.

FIG. 2 shows the bonding region of the bonded structure 100 in further detail, in a cross-section of the bonding region. The bonding region shown by FIG. 2 shows a qualitatively good first partial bond 202 between the bonding adhesive 108 and the second aluminium plate 104 and the and a qualitatively lesser second partial bond 204 between the bonding adhesive 108 and the first aluminium plate 102. The second partial bond 204 comprises a weak bonding region 210. In the weak bonding region 210, the bonding adhesive 108 still has its proper cohesive properties, but there is a lack of adhesion between the first aluminium plate 102 and the bonding adhesive 108.

FIG. 2 also shows the transmitter 112 and the receiver 114. The transmitter 112 is placed at about 5 to 10 centimetres from the bond 106 and the receiver 114 is placed at about 3 to 10 centimetres from the transmitter 112. Whereas the transmitter 112 may be placed between the bond 106 and the receiver 114, placement of the receiver 114 between the transmitter 112 and the bond 106 is preferred. In yet another alternative, the transmitter 112 and the receiver 114 are integrated in one and the same element, having functionality of and actuator as well as that of a sensor. A typical length of the bond 108 is 10 centimetres with a thickness between 0.5 and 3 millimetres.

Signals, in this embodiment acoustic signals, are generated by the transmitter 112. At least part of the acoustic signals propagate towards the bond 106, while passing along the receiver 114 where a direct signal is detected. The signal thus propagating from the transmitter 112 is partially reflected at various locations related to a transition. A first reflection 222 occurs at a proximal end 212 of the bond 106, a second reflection 224 occurs at a first intermediate location 216 being a proximal end of the weak bonding region 210. In formulas, the first intermedia location 216 is indicated as d1. A third reflection 226 occurs at a second intermediate location 218 being a distal end of the weak bonding region and a fourth reflection 228 occurs at a distal end 214 of the bond 106. In formulas, the second intermedia location is indicated as d2. A final part of the signal not reflected by any of the aforementioned locations propagates to the second aluminium plate 104. Reflected signals may be sensed by means of the receiver 114.

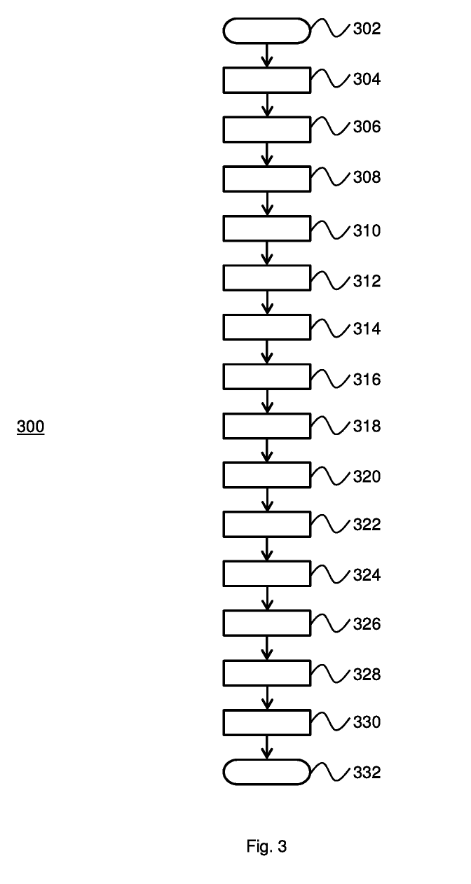

By determining and analysing characteristics of the transmitted signal and received reflected signal portions, quantitative parameters of the bond 106 may be determined. FIG. 3 shows a flowchart 300 depicting a procedure as an embodiment of a method for determining such quantitative parameters.

The steps of the procedure may be summarised as follows:
302 start of procedure
304 send signal
306 receive reflected signal
308 determine directly received signal portion
310 determine proximal end reflected portion
312 determine first intermediate reflected portion
314 determined second intermediate reflected portion
316 determined distal end reflected portion
318 determine first intermediate reflection coefficient
320 determine second intermediate reflection coefficient
322 determine first intermediate transmission coefficient
324 determine second intermediate transmission coefficient
326 determine characteristics distal end reflected portion
328 obtain data on intended reflection
330 determine equivalent bond length
332 end of procedure

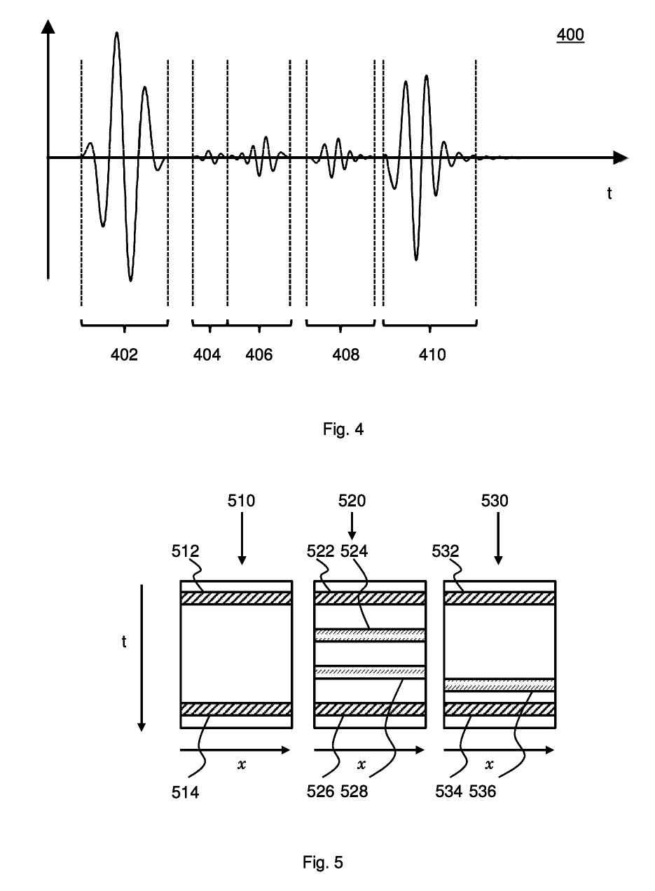

The procedure 300 starts with a terminator 302 as a start of the procedure. Subsequently, a signal is sent by the transmitter 112. As indicated above, the signal is preferably sent out as a pulse. Subsequent pulses may be sent out, carrying signals at one and the same or at different frequencies. Frequencies in the range from 50 kHz to 200 kHz are preferred, sent out in pulses of preferably 10 microseconds to 30 microseconds. In step 306, a signal 400 as depicted by FIG. 4 is received by the receiver 114. The received signal 400 comprises all reflections discussed above in conjunction with FIG. 2.

Of the received signal 400, a directly received portion 402 is determined in step 308. The directly received portion 402 is a portion of the signal sent out that passes along the receiver 114 before propagating towards the bond 106. Another portion of the received signal 400 is a proximal end reflection portion 404 that is reflected by the proximal end 212 of the bond 106, which is determined in step 310. In step 312, a first intermediate reflected portion 406 is determined in the received signal 400. The first intermediate reflected portion 406 is a part of the signal reflected by the first intermediate location 216. A second intermediate reflected portion 408, reflected by the second intermediate location 218, is determined in step 314. And in step 316, a distal end reflection portion 410 of the received signal 400 is determined in step 316.

Having received the various portions of the received signal 400 and having determined the various portions identified as reflections, the various portions of the received signal 400 are further analysed. In step 318, a first intermediate reflection coefficient is determined. This first intermediate reflection coefficient is determined is determined by firstly determining an amplitude of the first intermediate reflected portion 406 and an amplitude of the directly received portion 402. Second, the amplitude of the first intermediate reflected portion 406 is divided by the amplitude of the directly received portion 402.

In formula:

$${R}_{{z}_{d 1}} = \frac{{P}_{d 1}}{{P}_{direct}}$$

It is noted that to be more accurate, P_{direct} should be corrected with the transmission coefficient of the proximal end 212. However, this transmission coefficient is nearly one for most cases.

Subsequently, in step 320, a first intermediate transmission coefficient is determined. The first intermediate transmission coefficient is determined as one minus the first intermediate reflection coefficient.

In formula:

T_{z}_{_{d1}}=1−R_{z}_{_{d1}}

Likewise, in step 322, a second first intermediate reflection coefficient is determined. This second intermediate reflection coefficient is determined is determined by firstly determining an amplitude of the second intermediate reflected portion 408 and an amplitude of the directly received portion 402. Second, the amplitude of the second intermediate reflected portion 408 is divided by the product of the amplitude of the directly received portion 402 corrected with the first intermediate transmission coefficients.

In formula:

$${R}_{{z}_{d 2}} = \frac{{P}_{d 1}}{{T}_{{z}_{d 1}} {P}_{direct} {T}_{{z}_{d 1}}}$$

In the bottom part of the formula above, the transmission coefficient is mentioned twice, as the signal passes along the first intermediate location 216 two times: the original signal and the reflection. An assumption is that the transmission coefficient has the same value in both directions. These transmission coefficients are generally different, but an approximation can be made that they have the same value. Subsequently, in step 324, a second intermediate transmission coefficient is determined. The second intermediate transmission coefficient is determined as one minus the second intermediate reflection coefficient.

In formula:

T_{z}_{_{d2}}=1−R_{z}_{_{d2}}

In step 326 one or more characteristics on the distal end reflected portion 410 are determined. A first characteristic may be the (maximum) amplitude of the distal end reflected portion 410. In step 328, data is obtained on an intended reflection of the distal end 214 of the bond 206. With an intended reflection of the distal end 214, a reflection of the distal end 214 in an ideal situation is meant, with a perfect quality—or at least largely sufficient quality—of the bond 206. Preferably, such data has been obtained earlier and is stored in the memory module 156.

The data may be obtained earlier by conducting a large amount of measurements along the bond 206. In most practical cases, the vast majority of the bond 106 is in good, if not perfect condition. Therefore, if a large amount of data is collected on distal end reflections at various locations of the bond 106 and from that collected data, outliers are removed, data on an ideal response may be obtained. Alternatively or additionally, an average or median of the collected data is obtained. The collected data may relate to amplitude, power and/or energy of the reflected signal and the distal end reflected portion 410 in particular, another parameter or a combination thereof.

Alternatively or additionally, data on an intended reflection of the distal end 214 is obtained by means of simulations. Parameters obtained from the simulations may be the same as discussed above, like the amplitude, power and/or energy of the reflected signal and the distal end reflected portion 410 in particular, another parameter or a combination thereof. Alternatively or additionally, the simulation may yield a full transfer function of a pulse in a non-defective zone of the bond between the proximal end 212 and the distal end 214 of the bond 206.

Based on the data on the intended reflection, the various transmission and reflection factors and the actually received reflected signal. From a theoretical point of view, the reflected signal may be determined as follows:

$${P}^{defective} = {D}_{r} \{ \begin{matrix}\underbrace{\hat{X} ( {z}_{r} - {z}_{s} ) S ( {z}_{s} )}_{direct waves} + \\ \underbrace{\hat{X} ( {z}_{b} - {z}_{r} ) {R}_{{z}_{b}} \hat{X} ( {z}_{b} - {z}_{s} ) S ( {z}_{s} )}_{reflections from proximal end} + \\ \underbrace{\hat{X} ( {z}_{b} - {z}_{r} ) {T}_{{z}_{b}} \overline{X} ( {z}_{d 1} - {z}_{b} ) {R}_{{z}_{d 1}} \overline{X} ( {z}_{d 1} - {z}_{b} ) {T}_{{z}_{b}} \hat{X} ( {z}_{b} - {z}_{s} ) S ( {z}_{s} )}_{reflection from first intermediate location} + \\ \underbrace{\hat{X} ( {z}_{b} - {z}_{r} ) {T}_{{z}_{b}} \overline{X} ( {z}_{d 1} - {z}_{b} ) {T}_{{z}_{d 1}} \overline{X} ( {z}_{d 2} - {z}_{d 1} ) {T}_{{z}_{d 1}} \overline{X} ( {z}_{d 1} - {z}_{b} ) {T}_{{z}_{b}} \hat{X} ( {z}_{b} - {z}_{s} ) S ( {z}_{s} )}_{reflections from second intermediate location} + \\ \underbrace{\hat{X} ( {z}_{b} - {z}_{r} ) {T}_{{z}_{b}} \overline{X} ( {z}_{d 1} - {z}_{b} ) {T}_{{z}_{d 1}} \tilde{X} ( {z}_{d 2} - {z}_{d 1} ) {T}_{{z}_{d 2}} \overline{X} ( {z}_{e} - {z}_{d 2} ) {R}_{{z}_{c}} \overline{X} ( {z}_{e} - {z}_{d 2} ) {T}_{{z}_{d 2}} \tilde{X} ( {z}_{d 2} - {z}_{d 1} ) {T}_{{z}_{d 1}} \overline{X} ( {z}_{d 1} - {z}_{b} ) {T}_{{z}_{b}} \hat{X} ( {z}_{b} - {z}_{s} ) S ( {z}_{s} )}_{reflections from distal end} + \\ \underbrace{O ( {h}^{n} )}_{multiple scatterings}\end{matrix} \}$$

Wherein:

\hat{X}(z) is the transfer function for wave propagation in the first aluminium plate 102 outside the bonding region;

\tilde{X}(z) is the transfer function for wave propagation in the first aluminium plate 102 in the bonding region where the bond 106 is defective; and

X̅(z) is the transfer function for wave propagation in the first aluminium plate 102 in the bonding region where the bond 106 is not defective.

In a non-defective bond, reflections from the intermediate locations are considered not to be present. Therefore, an ideal response can be expressed by means of the following formula:

$${P}^{perfect} = {D}_{r} \{ \begin{matrix}\underbrace{\hat{X} ( {z}_{r} - {z}_{s} ) S ( {z}_{s} )}_{direct waves} + \\ \underbrace{\hat{X} ( {z}_{b} - {z}_{r} ) {R}_{{z}_{b}} \hat{X} ( {z}_{b} - {z}_{s} ) S ( {z}_{s} )}_{reflections from proximal end} + \\ \underbrace{\hat{X} ( {z}_{b} - {z}_{r} ) {T}_{{z}_{b}} \overline{X} ( {z}_{b + EBL} - {z}_{b} ) {R}_{{z}_{c}} \overline{X} ( {z}_{b + EBL} - {z}_{b} ) {T}_{{z}_{b}} \hat{X} ( {z}_{b} - {z}_{s} ) S ( {z}_{s} )}_{reflections from distal end} + \\ \underbrace{O ( {h}^{n} )}_{multiple scatterings}\end{matrix} \}$$

Wherein EBL is an equivalent bond length. It should be noted that with the measurement method discussed above, one-dimensional data is obtained—whereas the bond area is a two-dimensional entity. By obtaining one-dimensional data at various locations along the block arrow 116 (FIG. 1), a quality of the bond area or at least part thereof may be determined. From the obtained one-dimensional data, an equivalent bond length may be determined. With data obtained at several locations within a distance, an effective bond area may for example be determined by multiplying an average or median equivalent bond length by the distance.

With proper design of the inspection probe 110 and distance between the transmitter 112 and the receiver 114 in particular, separation of the direct signal and the reflections from the distal end 214 of the bond 206 can be ensured. The direct signal can be used for normalising the further portions of the received signal for calibration purposes. Under such conditions, the distal end reflected portions for an ideal bond and a defective bond may be approximated as follows:

P_{distal}^{defective}≈T_{z}_{_{b}}T_{z}_{_{d1}}T_{z}_{_{d2}}\hat{X}²(z_{b}−zᵣ)\tilde{X}²(z_{d2}−z_{d1})X̅²([z_{d1}−z_{b}]+[zₑ−z_{d2}])T_{z}_{_{d2}}T_{z}_{_{d1}}T_{z}_{_{c}}T_{z}_{_{b}}=

T_{z}_{_{b}}T_{z}_{_{d1}}T_{z}_{_{d2}}\hat{X}²(z_{b}−zᵣ)X̅²(EBL)T_{z}_{_{d2}}T_{z}_{_{d1}}T_{z}_{_{c}}T_{z}_{_{b}}

P_{distal}^{perfect}≈T_{z}_{_{b}}\hat{X}²(z_{b}−zᵣ)X̅²(l)R_{z}_{_{c}}T_{z}_{_{b}}

With l being the geometric length of the bond 106.

As discussed above, the intended and preferably ideal response of the distal end may be obtained experimentally or from simulations, as discussed above. The transmission coefficients at the first intermediate location (d₁) and the second intermediate location (d₂) may be determined as discussed above. However, for certain types of defects, like cohesive failure of the bonding adhesive 108, these values may be neglected as they tend to go to 1. This information combined with the equations directly above yields:

$${P}_{distal}^{perfect} \approx \frac{α {\overline{X}}^{2} ( l )}{{\overline{X}}^{2} ( EBL )} = α \overline{X} ( 2 [ l - EBL ] ) {P}_{distal}^{defective} , α = {T}_{{z}_{d 1}}^{- 1} {T}_{{z}_{d 2}}^{- 1} {T}_{{z}_{d 2}}^{- 1} {T}_{{z}_{d 1}}^{- 1}$$

This relation holds for any arbitrary frequency ω. This allows the equivalent bond length to be determined by convolving the right hand side of the equation directly above, a corrected distal signal portion, with an intended echo from the distal end of the bond. Of this term, an equivalent bond length is determined at which a norm of the convolution integrand is at a minimum.

In a formula, this yields:

$$arg {min}_{EBL ∈ {R}^{+}} ‖ \int ( α \overline{X} ( 2 [ l - EBL ] ) {P}_{distal}^{defective} - {P}_{distal}^{perfect} ) {e}^{- i ω t} d ω ‖ , \\ subject to 0 \leq EBL \leq l$$

In an ideal case, the minimum of the norm is zero, with the equivalent bond length being substantially equal to the intended bond length.

An explicit approximation to EBL can be obtained as:

$$EBL = l - \frac{1}{2} F ( ‖ \int ( \frac{{P}_{distal}^{perfect}}{α {P}_{distal}^{defective}} ) {e}^{- i ω t} d ω ‖ ) ,$$

where F(∥∫(X̅(γ))e^{-ωt}dω∥)=γ.

Which is determined in step 330 of the procedure depicted by the flowchart 300.

Once the equivalent bond length has been determined, a quantitative assessment of the bond 106 can be conducted. Such quantitative assessment may comprise determining failure load of the bond 106—a force applied to the bond 106 that results in rupture of the bond 106. Experimental data is known and may be further defined for determining a relation between equivalent bond length and failure load of the bond 106. In one embodiment, the Hart-Smith criterion is used.

FIG. 5 shows intensity graphs indicating intensity of various received signals. Time is depicted from top to bottom. X-location is depicted from left to right. Variations in x-direction may be the case when multiple transmitting and in particular receiving elements are used. These multiple transmitting and receiving elements are placed in the inspection probe 110 such that these elements are placed in a line substantially parallel to the bond 106 when the inspection probe 110 is in use. In the example provided by FIG. 5, all receiving elements receive the same signal. In the graphs provided by FIG. 5, thicker lines indicate higher intensity of the received signal. The intensity may be expressed in power or amplitude of the signal, where amplitude is preferred.

A first graph 510 indicates a first direct signal portion 512 and a first distal reflected portion 514. As no intermediate signal portions are present, the first graph 510 is considered to represent a response from a perfect bond.

A second graph 520 indicates a second direct signal portion 522 and a second distal reflected portion 526. The second graph 520 also shows a first intermediate reflected portion 524 and a second intermediate reflected portion 528. Presence of intermediate reflected portions may indicate a defective bond between two locations providing reflections shown in the second graph 520.

A third graph 530 indicates a third direct signal portion 532 and a third distal reflected portion 534. The third graph 530 also shows a third intermediate reflected portion 534.

Thus far, embodiments have been discussed in which the transmitter 112 and the receiver 114 are both operationally connected to the first element 102. Other embodiments may be envisaged in which the transmitter 112 is provided on another element than the receiver 114. In this way, a portion of a signal transmitted by the bonding region provided by the bonding material 108 and adjoining parts of the first element 102 and the second element 104 is received, rather than a signal portion reflected by the bonding region.

The transmitted signal portion travelling from the first element 102 to the second element 104 and the reflected signal portion reflected by the bonding region add up to the signal provided by the transmitter 112. With this assumption, the state of the bond 106 may also be determined by assessing the transmitted signal, rather than the reflected signal.

This assumption takes into account that certain portions of a signal provided by the transmitter 102 that are scattered or dissipated by the first element 102, the bonding material 108 and/or the second element 104, have a magnitude one or more orders smaller than a magnitudes of the reflected signal portion and the transmitted signal portion. Experimental data has shown that this assumption holds in at least the vast majority of cases.

Having obtained data on the transmitted signal portion, the equivalent bond length of the bond 106 may be determined by means of the following formula:

$$arg {min}_{EBL ∈ {R}^{+}} ‖ \int ( \overline{G} ( l - EBL ) {P}_{transmit}^{defective} - {P}_{transmit}^{perfect} ) {e}^{- i ω t} d ω ‖$$

$$subject to 0 \leq EBL \leq l$$

with G̅ being the transfer function for the waves going from the first element 102 to the second element 104.

In summary, a method and device are discussed for determining quantitative parameters of a bond between two elements, for example an adhesive bond between two aluminium plates of an aircraft. A pulsed wave is provided to a first element. The elements, including the bonded region, act as a waveguide. Any discontinuities, an end of the bonded region or imperfections, result in a change of parameters of the waveguide. This results in reflections. By analysing characteristics of the reflections, along with the actual bond length and a signal expected from a good quality bond, an equivalent bond length may be determined.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

In the description above, it will be understood that when an element such as layer, region or substrate is referred to as being “on” or “onto” another element, the element is either directly on the other element, or intervening elements may also be present.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

A person skilled in the art will readily appreciate that various parameters disclosed in the description may be modified and that various embodiments disclosed and/or claimed may be combined without departing from the scope of the invention.

1. Method of determining an effective area of a bond for binding a first element to a second element at a first location, the bonding region having a bonding length between a proximal end and a distal end, the method comprising:
Sending, by a transmitter operationally connected to the first element outside the bonding region and closer to proximal end than to the distal end, a transmitted signal to the bonding region via the first element;
Receiving, by a receiver operationally connect to the first element or the second element, a traveled signal resulting out of the transmitted signal having traveled through at least part of the bonding region;
Determining, from the received traveled signal, at least one value characterising the traveled signal;
Obtaining data on an intended traveled signal having traveled through an intended bonding region; and
Determining, based on the traveled signal, the value characterising the traveled signal and the bonding length, an equivalent bond length of the bonding region.

2. Method according to claim 1, wherein the traveled signal is a reflected signal being at least part of the transmitted signal reflected by the bonding region and wherein the receiver is operationally connected to the first element for receiving the reflected signal, the method further comprising:
Determining, from the reflected signal, a distal reflected signal portion reflected by the distal end of the bonding region; and
Determining, from the reflected signal, a first intermediate signal portion reflected by a first intermediate location in the bonding region between the proximal end and the distal end;
Wherein:
Determining at least one value characterising the first traveled signal comprises determining at least one value characterising the first intermediate signal portion;
Obtaining data on an intended traveled signal by an intended bonding region comprises obtaining data on an intended reflection by the intended bonding region; and
Determining an equivalent bond length of the bonding region is also based on the data on the intended reflection and the value characterising the first intermediate signal portion.

3. Method according to claim 2, further comprising
Determining, based on the value characterising the first intermediate signal portion, a first transparency factor of the first intermediate location; and
Determining, based on the intended reflection, the first transparency factor, the distal reflected signal, the value characterising the first intermediate signal portion, and the bonding length, an equivalent bond length.

4. Method according to claim 2, wherein the value characterising the first intermediate reflected signal portion is a first intermediate amplitude of the first intermediate reflected signal portion.

5. Method according to claim 2, further comprising:
Determining, from the reflected signal, a second intermediate signal portion reflected by a second intermediate location in the bonding region between the first intermediate location and the distal end; and
Determining at least one value characterising the second intermediate signal portion;
Wherein;
Determining the equivalent bond length is also based on the value characterising the second intermediate signal portion.

6. Method according to claim 5, further comprising determining, based on the value characterising the second intermediate signal portion, a second transparency factor of the second intermediate location, wherein determining the equivalent bond length is also based on the second transparency factor.

7. Method according to claim 5, wherein the value characterising the second intermediate reflected signal portion is a second intermediate amplitude of the second intermediate reflected signal portion.

8. Method according to claim 1, further comprising:
Obtaining a multitude of further received traveled signals at further locations;
Determining, from the multitude of further traveled signals, at least one value characterising each of the further traveled signals having traveled through the bonding region; and
Determining, based on at least one value characterising each of the further traveled signal portions, data on the intended signal having traveled through the intended bonding region.

9. Method according to claim 8, wherein the at least one value characterising the further traveled signal portions is a maximum amplitude of each of the further traveled signal portions.

10. Method according to claim 1, wherein the data on the intended traveled signal comprises an intended transfer function of the bonding region.

11. Method according to claim 2, wherein the data on the intended traveled signal comprises an intended transfer function of the bonding region and determining an effective area of the bond further comprises:
Adjusting the distal reflected signal portion based on the value characterising the first intermediate signal portion;
Convolving the adjusted distal reflected signal portion with the intended transfer function of the bonding region; and
Determining an effective area of the bond at which the convolution term has a minimum.

12. Method according to claim 11, wherein determining an effective area of the bond comprises determining an effective length of the bond, further comprising determining the equivalent bond length by determining an equivalent bond length, EBL, at which the following expression is at a minimum:
∥∫(αX̅(2[l−EBL])P_{distal}^{defective}−P_{distal}^{perfect})e^{-iωt}dω∥,
Wherein l is a length of the bond and the value of the equivalent bond length is a real value between 0 and the length of the bond.

13. Method according to claim 2, wherein the receiver and the transmitter are provided on the first element, the method further comprising:
Receiving, by the receiver, a direct signal from the transmitter received from the transmitter via a region of the first element provided between the transmitter and the receiver; and
Normalise the received reflected signal based on the received direct signal.

14. Device for determining an effective area of a bond for binding a first element to a second element by means of a transmitter connected to the first element and a receiver operationally connected to the first element or the second element, the bonding region having a bonding length between a proximal end proximal to the transmitter and a distal end distal to the transmitter, the device comprising:
An input unit arranged to receive, from the bonding region, by the receiver, a traveled signal resulting out of the transmitted signal having traveled through at least part of the bonding region; and
A processing unit arranged to:
Determine, from the traveled signal, at least one value characterising the traveled signal;
Obtain data on an intended traveled signal having traveled through an intended bonding region; and
Determine, based on the traveled signal, the value characterising the traveled signal and the bonding length, an equivalent bond length of the bonding region.

15. Computer programme product comprising code enabling a processing unit of a computer, when loaded in the processing unit, to execute the method according to claim 1.
